(19) United States
(12) Patent Application Publication
(10) Pub. No.: US 2003/0026270 A1
(43) Pub. Date: Feb. 6, 2003

(54) Antenna for wireless home network has UI functionality

(75) Inventor: Frederik Ekkel, Cupertino, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/920,245

(22) Filed: Jul. 31, 2001

(51) Int. Cl. H04L 12/28

(52) U.S. Cl. 370/401; 370/489

(57) ABSTRACT

A CE consumer apparatus, e.g., an STB is a gateway between a home network and an external data network The STB has an access point device for the home network. The access point device has a first functionality that enables broadband wireless RF data communication to the home network; and the access point device has a second functionality that serves as a user-interface. Because of the latter, the user will position the device in such as way that RF communication is not hampered by nearby obstacles.

### FIELD OF THE INVENTION

The invention relates to a wireless network, and especially, but not exclusively, to a home network with components that communicate in a wireless manner.

### BACKGROUND ART AND SUMMARY OF THE INVENTION

Technologies have become available to enable wireless connectivity of home appliances, such as set-top boxes (STBs), peripherals, PCs, etc. Examples of such wireless technology in the RF domain are, e.g., Bluetooth and 802.11. Bluetooth refers to a short-range RF technology for simplifying communications among devices and between devices and the Internet. The 802.11 refers to a family of specifications developed by the IEEE for a wireless LAN (local area network) technology. One of the advantages of being able to have appliances communicating in a wireless fashion is the absence of physical cables connecting them. Another advantage is that devices in separate rooms or on different floors can communicate as easily as if they were sitting next to each other. Accordingly, wireless LAN applications have become feasible.

An example of a LAN application is an STB that serves as the access point to the Internet for each PC and/or other data processing devices in the home. The software and the drivers required can be downloaded over the Internet to the STB via cable. The STB itself communicates with the PCs and/or the other devices using, e.g., an 802.11 protocol. To this end, the STB uses a wireless access point, e.g., an USB-based 802.11 dongle plugged into the proper USB port of the STB. The access point functions as the antenna for the RF communications between the STB and the PCs, peripherals and other devices on the home network.

An STB is typically positioned close to a TV display monitor. A problem with this configuration is that the consumer at home may not place the dongle in the best position. RF reception will be substantially hampered if the dongle is located next to or even behind the TV monitor. Since the STB was provided or specified by the network operator (cable operator, or MSO), the consumer is likely to ask the operator's help-desk for advice. Maintaining a help-desk is a relatively expensive operation, and any measure that is going to reduce the number of calls to the help-desk is highly relevant within this context. The inventor therefore proposes to provide the access point, or dongle, with one or more additional features that let the consumer position the access point, as if it were done automatically, in the proper place, e.g., on top of the TV display monitor. An added feature is, for example, an IR remote control receiver for control of the TV and/or other equipment on the home network, or for cooperation with a wireless keyboard. Another added feature is, for example, one or more status LEDs, typically found at the front of the STB bezel (e.g., red=email message waiting; yellow=connected; green=power on). Yet another added feature is a solid state still picture or video camera for video conferencing. Thus, the consumer is given good reasons to put the access point on top of the TV, while getting as a bonus a reliable 802.11 communication.

Accordingly, the invention relates to a consumer electronics (CE) apparatus that comprises a gateway between a home network and an external data network. The apparatus has an access point device for the home network. The access point device has a first functionality that enables broadband wireless data communication to the home network. The access point device has a second functionality that serves as a user-interface. Preferably, the access point device is connected to the apparatus via a cable. The access point device may comprise, for example, an IR receiver; one or more visual status indicators (e.g., the status LEDs mentioned above); a (solid state) camera; or a microphone. The invention also relates to an access point device for use with such a CE apparatus.

### BRIEF DESCRIPTION OF THE DRAWING

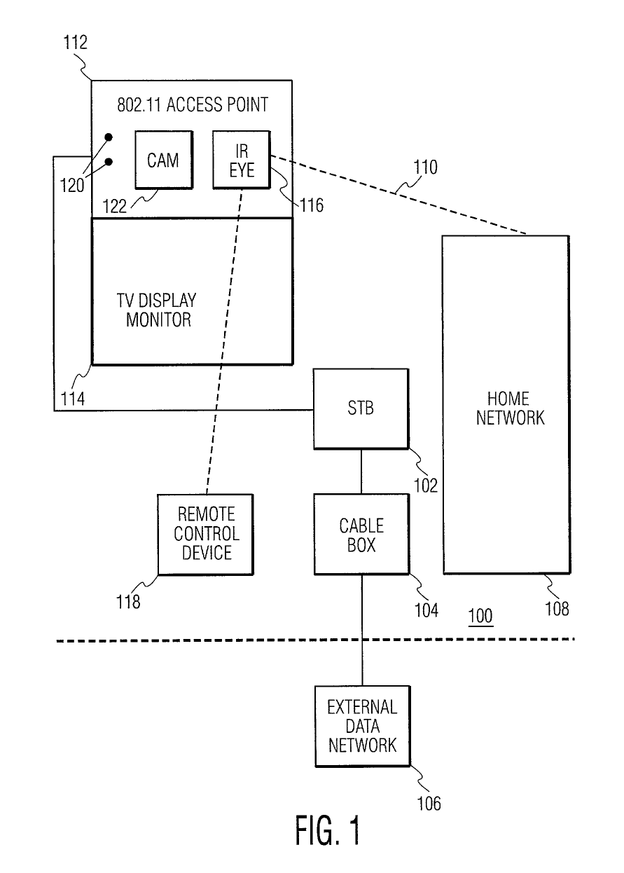

The invention is further explained below, by way of example and with reference to the accompanying drawing, wherein FIG. 1 is a diagram of a system in the invention.

### DETAILED EMBODIMENTS

FIG. 1 is a block diagram of a system 100 in the invention. System 100 comprises a STB 102 that is connected to a cable box 104 for access to a data network 106, e.g., the Internet. System 100 comprises a home network 108 with, e.g., PCs, peripherals (display monitors, loudspeakers) etc. STB 102 communicates with appliances on home network 108 using an RF wireless technology 110, e.g., 802.11. To this end, an access point device 112 is connected to STB 102, e.g., via a USB port on STB 102. Access point 112 serves as an RF antenna.

The user of system 100 needs to position device 112 in such as way that RF communication 110 is not hampered by obstacles close by antenna 112. In order to have the user automatically position antenna 112 in a good spot, for example, on top of a TV display monitor 114, device 112 is provided with one or more UI feature. For example, device 112 has an IR receiver 116 to enable the user to control, through an IR remote controller 118, a TV receiver (not shown), a DVD player (not shown) or another apparatus on home network 108 for which monitor 114 serves as the output device. It is quite natural for the user to point remote 118 in the direction of monitor 114 to control video output. Accordingly, the position of device 112 on top of monitor 114 is completely legitimate and consistent with the expectation of the user. In addition, or alternatively, device 112 has one of more status lights 120. Lights 120 may indicate some states of network 108, of STB 102, or states associated with a certain functionality or application on network 110 or STB 102. The example of power, stand-by, or “email message waiting” has been mentioned above. As yet another functionality that can be added to device 112 so as to have the user position it on top of monitor 114 is that of a PC camera 122 for use with video conferencing or to take a picture (visual feedback via monitor 114), etc. Yet another functionality that can be added is that of microphone (not shown here). Yet another functionality may be a FLASH memory card slot for the reception of a FLASH memory card. The card stores, e.g., digital pictures that can be rendered on TV monitor 114 under control of STB 102 or another apparatus on home network 108. This or another functionality added to antenna 112 help to facilitate the user to position it in the proper spot with regard to RF reception and transmission.

Herein incorporated by reference:

U.S. Ser. No. 09/519,546 (attorney docket US 000014) filed Mar. 6, 2000 for Erik Ekkel et al., for PERSONALIZING CE EQUIPMENT CONFIGURATION AT SERVER VIA WEB-ENABLED DEVICE. This document relates to facilitating the configuring of CE equipment by the consumer by means of delegating the configuring to an application server on the Internet. The consumer enters his/her preferences in a specific interactive Web page through a suitable user-interface of an Internet-enabled device, such as a PC, a set-top box or a digital cellphone. The application server generates the control data based on the preferences entered and downloads the control data to the CE equipment itself or to the Internet-enabled device.

U.S. Ser. No. 09/653,784 (attorney docket US 000220) filed Sep. 1, 2000 for Frank Caris et al., for STB CONNECTS REMOTE TO WEB SITE FOR CUSTOMIZED CODE DOWNLOADS. This document relates to marketing an STB together with a programmable remote. The remote has a dedicated button to connect the STB to a specific server on the Internet. The consumer can notify the server of his/her other CE equipment, which he/she desires to be controllable through the same remote as the one that came with the STB. The server downloads to the STB data representative of the relevant control codes. The STB is provided with means to program the remote with these codes. In return the server has obtained detailed and accurate information about this consumer's equipment. A reliable customer base can thus be built for streamlining Help Desk operations.

U.S. Ser. No. 09/844,570 (attorney docket US 018052) filed Apr. 26, 2001 for Eugene Shteyn for DISTRIBUTED STORAGE ON A P2P NETWORK ARCHITECTURE. This document relates to an electronic content delivery system that uses a network of end-user devices around a hub. Each end-user device has storage capability. Content is stored in a distributed fashion on the network of these end-user devices for being made available to individual ones of these devices in a P2P fashion so as to cut download time and reduce transmission errors.

What is claimed is:

1. A CE consumer apparatus comprising a gateway for use between a home network and an external data network, wherein:
the apparatus has an access point device for the home network;
the access point device has a first functionality that enables broadband wireless data communication to the home network; and
the access point device has a second functionality that serves as a user-interface.

2. The apparatus of claim 1, wherein the access point device is connected to the apparatus via a cable.

3. The apparatus of claim 1, wherein the access point device comprises an IR receiver.

4. The apparatus of claim 1, wherein the access point device comprises a visual status indicator.

5. The apparatus of claim 1, wherein the access point comprises a camera.

6. The apparatus of claim 1, wherein the access point comprises a microphone.

7. The apparatus of claim 1, wherein the access point comprises a FLASH memory card slot.

8. For use with a CE consumer apparatus that comprises a gateway for being used between a home network and an external data network: an access point device for the home network, wherein:
the access point device has a first functionality that enables broadband wireless data communication to the home network; and
the access point device has a second functionality that serves as a user-interface.

9. The device of claim 8, wherein the access point device is connectable to the apparatus via a cable.

10. The device of claim 8, comprising an IR receiver.

11. The device of claim 8, comprising a visual status indicator.

12. The device of claim 8, comprising a camera.

13. The device of claim 8, comprising a microphone.

14. The device of claim 8, comprising a FLASH memory card slot for digital still images
